(19) United States
(12) Patent Application Publication
(10) Pub. No.: US 2016/0133087 A1
(43) Pub. Date: May 12, 2016

(54) GAMING MACHINE WITH BONUS FEATURE

(71) Applicant: Rising Digital Corp., Las Vegas, NV (US)

(72) Inventors: Aimin Cong, Las Vegas, NV (US); Sam Farrage, Henderson, NV (US)

(21) Appl. No.: 14/537,853

(22) Filed: Nov. 10, 2014

(51) Int. Cl. G07F 17/32; G07F 17/34

(52) U.S. Cl. CPC G07F 17/3213; G07F 17/34

(57) ABSTRACT

An electronic gaming machine, including systems and methods, for providing one or more bonus features which in some embodiments include the display of a bonus array over a symbol displayed in a cell of the underlying game array.

### BACKGROUND OF THE INVENTION

The invention relates generally to electronic gaming equipment, and more particularly, to an electronic gaming machines, games and special or bonus game features that may be offered to facilitate and encourage game play thereon.

Gaming machines, have become a major source of entertainment in many parts of the world. Traditionally such machines were mechanical devices where a number of reels marked with a plurality of numbers or symbols could be made to spin randomly by the application of some mechanical input. If, upon coming to a rest, the subsequent patterns of numbers or symbols displayed along a “payline” of symbol locations on the reels corresponded to predetermined patterns, then the machine would provide a prize or payout.

At one time a slot machine payline included only straight line arrangements of symbol locations across each cell in the array formed by the reels. The advent of electronics, computers and electronic graphical displays, has enabled a continual increase in the complexity and variations of gaming machines, games and displays, while maintaining the basic concept of the traditional machine. In short, the games no longer include mechanical reels but simulate rotatable reels to ultimately display a array of locations in which a symbol is displayed. These games also typically include multiple paylines many of which are not straight lines, and each cell may comprise a reel, such that every symbol in each cell is randomly selected. However, the paylines remain predefined to include specific arrangements of symbol locations in the reel array.

Bonus games that may be played in conjunction with the underlying slot game are often used to enhance the entertainment value of the game. The bonus game may comprise any type of game, either similar to or completely different from the primary game. The bonus game is typically initiated upon the occurrence of a selected event or outcome of the underlying game, but may also require an additional wager.

To keep games appealing to players there is a continuing need to develop new features and bonus games. New features are necessary to appeal to player interest and enhance excitement in order to entice longer play and satisfy demands of operators for interesting games and increased profitability.

### SUMMARY OF THE INVENTION

The invention relates generally to a gaming machine, including methods and systems, which resolve the aforementioned issues in the art, among other things.

Some embodiments of the invention are directed to an electronic gaming machine comprising: a game controller for controlling the display of randomly-generated symbols in an array on the display for an underlying game, including a bonus feature wherein the display of one or more preset combinations of symbols on the array triggers a bonus payout based on the amount and statistical odds of achieving the preset combinations.

In some embodiments, the symbols include underlying game symbols and unique bonus feature symbols, wherein the bonus feature symbols are included in the underlying game for determining an outcome of the underlying game, but the underlying game symbols are not included in the determination of the outcome of the bonus feature. In some embodiments, the bonus feature symbols are representative of playing cards, such as Ace, King, Queen, Jack and Ten.

Some embodiments of the invention are directed to an electronic gaming machine comprising: a game controller for controlling the display of randomly-generated symbols in an array on the display for an underlying game, including a bonus feature enabling the customization of a payline through the selection of cells to be included in the customized payline, wherein the display of one or more preset combinations of symbols in the cells of the customized payline triggers a bonus payout based on the amount and statistical odds of achieving the preset combinations.

Some embodiments of the invention are directed to an electronic gaming machine comprising: a game controller for controlling the display of randomly-generated symbols in an array on the display for an underlying game, including a bonus feature actuating the presentation of a pop-up array superimposed over the array of the underlying game, wherein the game controller controls the display of randomly-generated symbols in the pop-up array and the display of one or more preset combinations of symbols in the cells of the pop-up array triggers a bonus payout based on the amount and statistical odds of achieving the preset combinations.

In some embodiments, bonus pays are evaluated independently from one another, or in combination with symbols appearing in the underlying game.

Some embodiments of the invention are directed to an electronic gaming machine comprising: a display for displaying an underlying game, wherein the underlying game comprises displaying randomly-selected symbols arranged into an underlying game array of cells, wherein preset winning combinations of the randomly selected symbols in the underlying game array actuate the award of prizes; and a controller for controlling the display of randomly-selected symbols in each cell of the underlying game array, analyzing the underlying game array to detect preset winning combination, and detecting the random-selection of a bonus feature trigger symbol in a cell of the underlying game array, the controller configured to actuate a bonus feature responsive the detection of the bonus feature trigger symbol, wherein the bonus feature comprises the display of randomly-selected symbols arranged into a bonus feature array of cells, the bonus feature array of cells being positioned on the display over the cell in the underlying game array having the bonus feature trigger.

In some embodiments of the aforementioned electronic gaming machine the controller replaces a portion of the randomly-selected symbols in the underlying game array shown on the display with the randomly-selected symbols in the bonus feature array shown on the display, and is further configured to analyze the underlying game array with replaced symbols to detect preset winning combinations.

In some embodiments of the aforementioned electronic gaming machine the controller analyzes the underlying game array with the randomly-selected symbols in the bonus feature array to detect preset winning combinations responsive to the actuation of the bonus feature.

In some embodiments of the aforementioned electronic gaming machine the controller actuates a second bonus feature responsive to the detection of a bonus feature trigger in the randomly-selected symbols in the cells of the bonus feature array.

In some embodiments of the aforementioned electronic gaming machine the controller analyzes the bonus feature array to detect preset winning combinations, wherein the randomly-selected symbols include poker symbols and the preset winning combinations include poker hands.

In some embodiments of the aforementioned electronic gaming machine the controller is further configured to receive selections of one or more cells in the underlying game array prior to the play of the underlying game, and actuate the bonus feature responsive to the bonus feature trigger symbol being detected in the one or more selected cells.

Some embodiments of the invention are directed to an electronic gaming machine comprising: a display for displaying an underlying game, wherein the underlying game comprises displaying randomly-selected symbols arranged into an underlying game array of cells, wherein preset winning combinations of the randomly selected symbols in the underlying game array actuate the award of prizes; and a controller for controlling the display of randomly-selected symbols in each cell of the underlying game array, analyzing the underlying game array to detect preset winning combination, and detecting the random-selection of a bonus feature trigger symbol in a cell of the underlying game array, the controller configured to actuate a bonus feature responsive the detection of the bonus feature trigger symbol, the bonus feature comprising the display of randomly-selected symbols arranged into a bonus feature array of cells, the bonus feature array of cells being positioned on the display over the cell in the underlying game array having the bonus feature trigger, wherein the controller is further configured to receive selections of one or more cells in the underlying game array prior to the play of the underlying game, and actuate the bonus feature responsive to the bonus feature trigger symbol being detected in the one or more selected cells.

Some embodiments of the invention are directed to an electronic gaming machine comprising: a display for displaying an underlying game, wherein the underlying game comprises displaying randomly-selected symbols arranged into an underlying game array of cells, wherein preset winning combinations of the randomly selected symbols in the underlying game array actuate the award of prizes; and a controller for controlling the display of randomly-selected symbols in each cell of the underlying game array, analyzing the underlying game array to detect preset winning combination, and detecting the random-selection of a bonus feature trigger symbol in a cell of the underlying game array, the controller configured to actuate a bonus feature responsive the detection of the bonus feature trigger symbol, the bonus feature comprising the display of randomly-selected symbols arranged into a bonus feature array of cells, the bonus feature array of cells being positioned on the display over the cell in the underlying game array having the bonus feature trigger, wherein the controller replaces a portion of the randomly-selected symbols in the underlying game array shown on the display with the randomly-selected symbols in the bonus feature array shown on the display, and is further configured to analyze the underlying game array with replaced symbols to detect preset winning combinations.

### BRIEF DESCRIPTION OF THE DRAWINGS

Other advantages of the invention will be readily appreciated as the same becomes better understood by reference to the following detailed description when considered in connection with the accompanying drawings wherein:

FIG. 1 is a perspective view of an exemplary electronic gaming machine which may be configured in accordance with the bonus feature embodiments of the invention;

FIG. 2 is an exemplary display of an array for purposes of illustrating a bonus feature of the invention;

FIGS. 3-4 are exemplary displays of an array for purposes of illustrating another bonus feature of the invention; and

FIGS. 5-7 are exemplary displays of arrays for purposes of illustrating yet another bonus feature of the invention.

### DETAILED DESCRIPTION OF VARIOUS EMBODIMENTS OF THE INVENTION

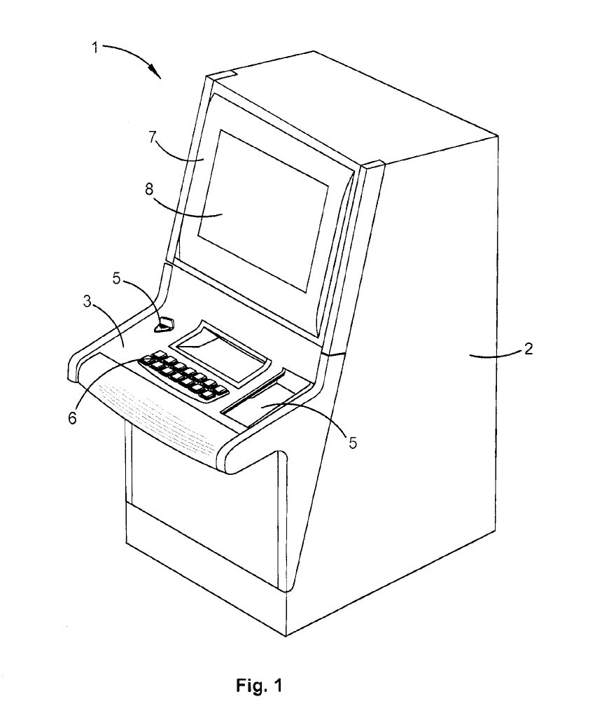

For the purposes of promoting an understanding of the principles in accordance with the embodiments of the present invention, reference will now be made to the exemplary non-limiting embodiments illustrated in the drawings and specific language will be used to describe the same. It will nevertheless be understood that no limitation of the scope of the embodiments of the present invention is thereby intended. Any alterations and further modifications of the inventive feature illustrated herein, and any additional applications of the principles of the embodiments of the present invention as illustrated herein, which would normally occur to one skilled in the relevant art and having possession of this disclosure, are to be considered within the scope of the present invention as claimed. The following detailed description provides systems and methods which may be employed on computer based electronic gaming machines having display devices, such as exemplary electronic gaming machine 1 shown in FIG. 1, which is described below and discussed in connection with the bonus features of the invention for illustrative purposes.

Electronic gaming machine 1 includes a cabinet 2, a console 3 and an internal electronic game controller 4. The console 3 may have various input devices including vending slots 5 for receiving monetary bets or tickets and a plurality of buttons 6 for actuation by a player. The electronic game controller 4 is generally in the form of a central processing unit, such as a computer and/or a SMIB board, and is in electronic communication with a display in the form of a display device 7, as well as various input devices on the console 3. It is also appreciated that a person skilled in the art would readily understand the location and use of the electronic game controller 4 in the electronic gaming machine 1.

The display device 7 may also display other standard game information, including rules of play, the number of preset selectable pay lines available, the amount of credits per line, the amount of player credits the amount of the current bet wagered by the player, the amount of wins by the player, a message area, a general menu button and a current denomination button indicating the currently selected base bet denomination.

The electronic game controller 4 is programmed to provide an underlying game 8 on the electronic gaming machine 1 for play by a player, as best shown in FIG. 1. The game 8 in this embodiment is a slot game having simulated reels of game symbols which form an array or array on the display device 7. While the array may include five columns and three rows as shown in the exemplary embodiments herein, it will be appreciated by one skilled in the art that other arrays could be used, such as 3×3, 4×3, 5×5, 4×4, etc., or the array can have an uneven number of rows and/or columns.

The array of game 8 defines cells in which the game symbols appear. The array 10 is arranged so that a player can select one or more predetermined paylines defined on the array, which correspond to combinations of cells across the array displayed on display device 7. The paylines correspond to the lines selected by the player and generally comprise at least one cell from each reel. The number of paylines that can be selected by the player typically depends on the amount of the monetary bet for playing game 8. The electronic game controller 4 randomly determines the appearance of game symbols in the cells of the array. The game symbols may include a mixture of picture symbols (such as animal symbols, playing card symbols, scatter symbols, wild card symbols, etc.) along with trigger symbols or combinations thereof that result in a triggering event that actuates a bonus feature, such as one of the bonus features of the invention as described herein.

The player initially makes a bet using vending slots 5 initiate play of the electronic gaming machine 1 to build up credit to play game 8. For example, the player can bet or wager monetary amounts equivalent to a particular amount of credits, depending on the bet denomination selected for the game 8. Also, the player can make any additional side bets during play of the game 8 once the game has commenced to access additional features in the game, such as increasing the number of winning combinations in the game or bonus features as described herein.

The electronic game controller 4 then causes the reels to simulate the appearance of visibly rotating or “spinning”, and randomly display the game symbols in each cell. Should a triggering event occur, then one or more of the bonus features of the invention may be actuated.

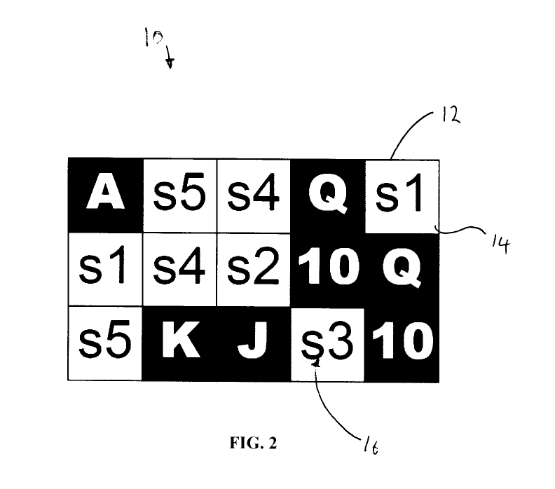

FIG. 2 illustrates a first bonus feature of the invention which is generally referred to hereinafter as bonus feature 10. Bonus feature 10 is illustrated on array 12 having cells 14 shown on a display device 7. Bonus feature 10 may be applied and utilized after each spin or game, may occur only upon or the spin immediately after a triggering event, such as players receiving a trigger symbol or upon the occurrence of another bonus or event in the underlying game, or the may be available for every game in which a player wagers the maximum amount allowable in the game, that is, “maxbet.”

Once the bonus feature is triggered, such as after each spin, the electronic game controller 4 having randomly determined the appearance of symbols 16 in each cell 14 or array 12 (represented by the “s1, s2, s3, s4, s5,” as shown) may then, at the conclusion of the reel spin of the underlying game 8, determine if the symbols 16 of any of the cells in array 12 includes one or more preset bonus feature combinations of symbols. Thus, controller 4 considers symbols 16 irrespective of paylines for determining bonus feature 10. For example, as shown in this embodiment, if the cells 14 of array 12 include the symbols 16 making up poker hands, such as a pair, two-pair, three of a kind, straight (as shown, consisting of Ace, King, Queen, Jack, and ten), full house, four of a kind then a bonus payout may be awarded. Symbols may include suits or colors, and therefore preset bonus feature combinations may include symbols forming a flush, straight flush or royal flush, or the like.

In this embodiment of bonus feature 10, symbols may be used more than once to form as many preset combinations as possible, such as in the case of poker hands, the Queen and Ten may be used twice. For example, in addition to the royal flush shown in array 12, a hand of two-pair consisting of the Queens and Tens is also formed by re-using a Queen and a Ten from the royal flush. Thus, in this embodiment a payout may be received in connection with the royal flush and the two-pair hand independently, or based on the total number and rank of poker hands that may be formed by all of the symbols 16 shown in array 12 after a reel spin. Bonus feature 10 may consider both the odds of the patterns formed, such as for example, hand ranks like royal flush, straight or four of a kind which have lower odds of occurrence, as well as the number of hands or combinations formed, when determining the payout award.

The electronic game controller 4 therefore determines whether there are any predetermined winning patterns or combinations of symbols 16 appear on array 12, such as “three of a kind”, “four of a kind” and “five of a kind” and/or other combinations of a “full house”, “straight” or “flush” where the symbols represent playing cards or actually depict playing cards. It will be appreciated that other winning combinations of symbols 16 can also be provided, and that as mentioned above, the symbols may be other symbols than playing card symbols, such as animals, signs, pictures, letters, etc. If the preset winning patterns or combinations are formed, then the electronic game gaming machine 1 enters a winning game state and awards a prize or payout award. The payout award may be additional free spins or credits, both or anything of value.

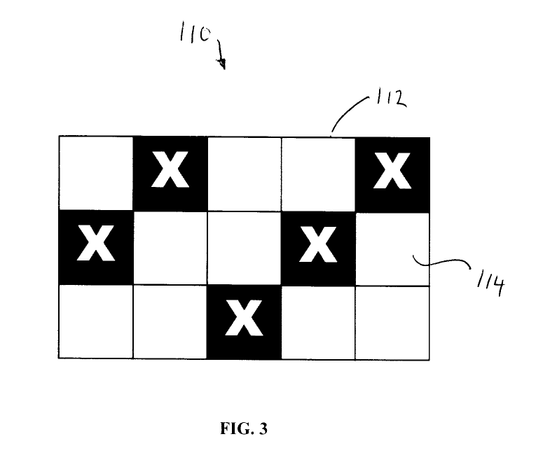

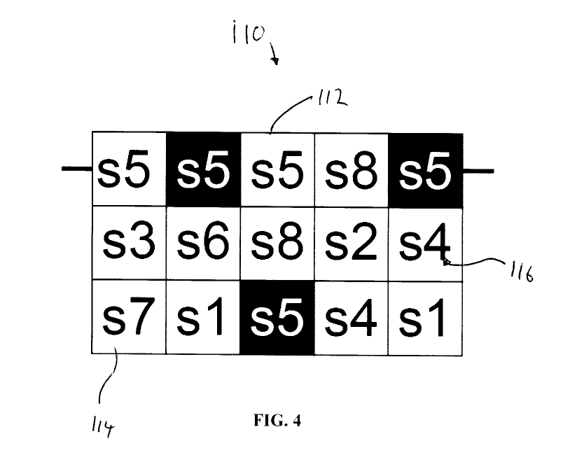

FIG. 3 and FIG. 4 illustrate another bonus feature of the invention generally referred to hereinafter as bonus feature 110.

Bonus feature 110 provides for the customizable paylines on array 112. Paylines may be customized by players selecting cells 114 on array 112, such as by physically touching cells 114 displayed on a touch-sensitive display device 7 to be included in a customized payline prior to a reel spin of game 8. In some embodiments, customized paylines may be formed by controller 4 randomly-selecting cells 114 on array 112, either prior to a reel spin, or at the conclusion of a reel spin. In some embodiments, customizable paylines may be formed over time or play on gaming machine 1, that is, a customizable payline may start with one or more cells 114 and then cells 114 of array 112 may be added or allowed to be added to the payline as game play of game 8 continues. In other embodiments, the amount of cells 114 which may be included on a customized payline may depend on the amount wagered, with “maxbet” enabling the selection of the most cells 114, or allowing for the most cells 114 to be randomly-selected by controller 4 as part of the customized payline.

In some embodiments, the amount of cells which may be included in a payline is equal to the amount of cells included in a predetermined payline in game 8, whereas in other embodiments, more (up to all of the cells 114 in array 112) or less cells 114 may be included in the payline. The number of cells 114 selected for the payline may impact the payout or prize awarded should a bonus feature combination of symbols be received in the customized payline.

In some embodiments, a portion of cells 114 forming a customized payline may be player-selected prior to the start of a game, and the remaining portion of cells 114 in the payline may be randomly-selected by controller 4 prior to the reel spin or thereafter.

FIG. 3 illustrates five cells 114 being selected, randomly, by a player, or a combination thereof, as represented by the shaded cells 114 having “X” therein. FIG. 4 illustrates the results of a reel spin in which a symbol 116 identified as “s5” appears three times. Thus, as discussed with regard to bonus feature 10, if controller 4 determined that three of the same symbol is one of the preset bonus feature combinations, then a payout may be awarded as a result.

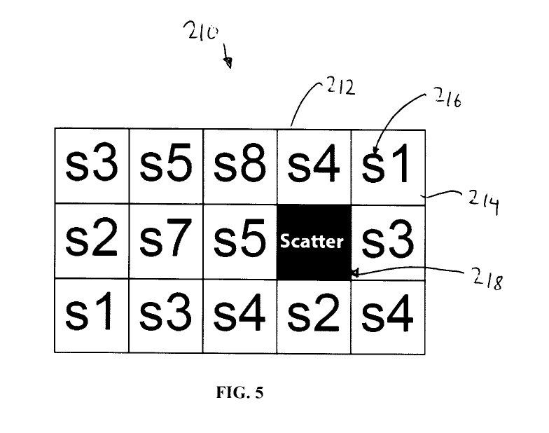

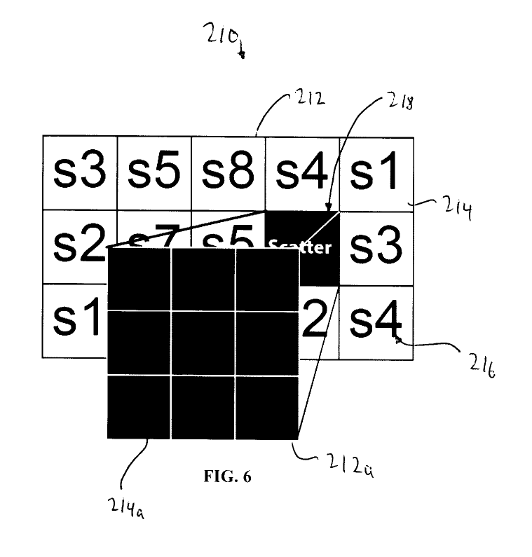

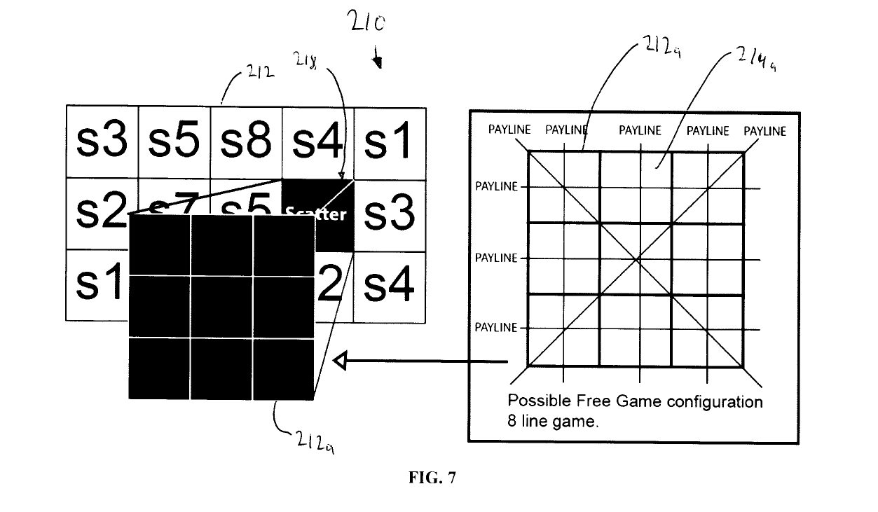

FIG. 5, FIG. 6 and FIG. 7 illustrate yet another bonus feature of the invention generally referred to as bonus feature 210.

Bonus feature 210 provides a bonus feature trigger symbol 218, which may be a “scatter” symbol as shown in FIG. 5, or other type of symbol. Upon controller 4 detecting the appearance of the bonus feature trigger symbol in a cell 214 of array 212 in a reel spin result, a new array 212a will be displayed as a “pop-up” emanating from the cell 214 having the trigger symbol as shown in FIG. 6.

In some embodiments, as shown in FIG. 7, new array 212a may be displayed as a 3×3 grid having paylines as shown and providing one or more free bonus spins. The bonus spin may occur and payout according to any scheme or such as described above in bonus feature 10, that is, based on the amount and ranking of preset combinations achieved in the array 212a. In some embodiments, a bonus feature trigger symbol 218 may occur in a cell 214a of the reel spin result of array 212a, thus actuating a similar pop-up array (i.e., 212b which is not shown). The additional arrays may be of the same grid size or smaller than 212a.

In some embodiments, the result of the bonus reel spin array 212a may be superimposed on or over array 212 of the game 8 display, that is, the underlying game reel spin results, such that the underlying game is reevaluated based on the newly added symbols from the bonus reel spin. For example, array 212a may be presented as a pop-up emanating from the trigger symbol and then be shown through animation as becoming part of the underlying game reel spin array 212, such that the symbols of array 212a replace, or in some embodiments are combined with, symbols in cells 216 of array 212. Thereafter, game controller 4 will determine the appropriate payout or award for the underlying game 8 based on the change to array 212, and respond to any additional bonus trigger symbols 218 that may be within array 212a. In this embodiment, the reel spin results in the underlying game are therefore changed by bonus feature 210.

It should be readily apparent that other grid sizes and paylines may be used, including customizable paylines as described by bonus feature 110. In addition, it should be understood that features of the bonus features 10, 110 and 210 as described herein may be combined together to form various bonus features. For example, a bonus feature 210 may be combined with bonus feature 110 such that the bonus feature trigger symbol 218 must be in a cell which is part of a customized payline.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a controller may include a processor, which as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, the system may include a database, which as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Other aspects and features of the invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Those skilled in the art will readily appreciate that the systems and methods described herein may be a standalone system, gaming device, gaming machine or incorporated in an existing gaming system or machine. The gaming machine of the invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the invention so long as players and operators thereof are provided with useful access thereto, either through a mobile device, gaming platform, or other computing platform via a local network or global telecommunication network.

Although specific features of various embodiments of the invention may be shown in some drawings and not in others, this is for convenience only. In accordance with the principles of the invention, any feature of a drawing may be referenced and/or claimed in combination with any feature of any other drawing.

Those skilled in the art will readily appreciate that the apparatus described herein may include various computer and network related software and hardware, such as programs, operating systems, memory storage devices, data input/output devices, data processors, servers with links to data communication systems, wireless or otherwise, and data transceiving terminals. Those skilled in the art will further appreciate that the precise types of software and hardware used are not vital to the full implementation of the apparatus of the invention so long as it performs as described in at least one of the embodiments herein.

While exemplary apparatus, systems and methods of the invention have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth by the claims and any equivalents thereto.

What is claimed is:

1. An electronic gaming machine comprising:
a) a display for displaying an underlying game, wherein the underlying game comprises displaying randomly-selected symbols arranged into an underlying game array of cells, wherein preset winning combinations of the randomly selected symbols in the underlying game array actuate the award of prizes; and
b) a controller for controlling the display of randomly-selected symbols in each cell of the underlying game array, analyzing the underlying game array to detect preset winning combination, and detecting the random-selection of a bonus feature trigger symbol in a cell of the underlying game array, the controller configured to actuate a bonus feature responsive the detection of the bonus feature trigger symbol, wherein the bonus feature comprises the display of randomly-selected symbols arranged into a bonus feature array of cells, the bonus feature array of cells being positioned on the display over the cell in the underlying game array having the bonus feature trigger.

2. An electronic gaming machine as recited in claim 1, wherein the underlying game array and bonus feature array are defined by rows and columns, wherein the underlying game array has a greater amount of one of rows or columns than the bonus feature array.

3. An electronic gaming machine as recited in claim 1, wherein the controller replaces a portion of the randomly-selected symbols in the underlying game array shown on the display with the randomly-selected symbols in the bonus feature array shown on the display, and is further configured to analyze the underlying game array with replaced symbols to detect preset winning combinations.

4. An electronic gaming machine as recited in claim 1, wherein the controller analyzes the underlying game array with the randomly-selected symbols in the bonus feature array to detect preset winning combinations responsive to the actuation of the bonus feature.

5. An electronic gaming machine as recited in claim 1, wherein the controller actuates a second bonus feature responsive to the detection of a bonus feature trigger in the randomly-selected symbols in the cells of the bonus feature array.

6. An electronic gaming machine as recited in claim 1, wherein the controller analyzes the bonus feature array to detect preset winning combinations, wherein the randomly-selected symbols include poker symbols and the preset winning combinations include poker hands.

7. An electronic gaming machine as recited in claim 1, wherein the controller is further configured to receive selections of one or more cells in the underlying game array prior to the play of the underlying game, and actuate the bonus feature responsive to the bonus feature trigger symbol being detected in the one or more selected cells.

8. An electronic gaming machine as recited in claim 7, wherein the display is a touchscreen display.

9. An electronic gaming machine comprising:
a) a display for displaying an underlying game, wherein the underlying game comprises displaying randomly-selected symbols arranged into an underlying game array of cells, wherein preset winning combinations of the randomly selected symbols in the underlying game array actuate the award of prizes; and
b) a controller for controlling the display of randomly-selected symbols in each cell of the underlying game array, analyzing the underlying game array to detect preset winning combination, and detecting the random-selection of a bonus feature trigger symbol in a cell of the underlying game array, the controller configured to actuate a bonus feature responsive the detection of the bonus feature trigger symbol, the bonus feature comprising the display of randomly-selected symbols arranged into a bonus feature array of cells, the bonus feature array of cells being positioned on the display over the cell in the underlying game array having the bonus feature trigger, wherein the controller is further configured to receive selections of one or more cells in the underlying game array prior to the play of the underlying game, and actuate the bonus feature responsive to the bonus feature trigger symbol being detected in the one or more selected cells.

10. An electronic gaming machine as recited in claim 9, wherein the underlying game array and bonus feature array are defined by rows and columns, wherein the underlying game array has a greater amount of one of rows or columns than the bonus feature array.

11. An electronic gaming machine as recited in claim 9, wherein the the controller replaces a portion of the randomly-selected symbols in the underlying game array shown on the display with the randomly-selected symbols in the bonus feature array shown on the display, and is further configured to analyze the underlying game array with replaced symbols to detect preset winning combinations.

12. An electronic gaming machine as recited in claim 9, wherein the controller analyzes the underlying game array with the randomly-selected symbols in the bonus feature array to detect preset winning combinations responsive to the actuation of the bonus feature.

13. An electronic gaming machine as recited in claim 9, wherein the controller analyzes the bonus feature array to detect preset winning combination, and detecting the random-selection of a bonus feature trigger symbol in a cell of the underlying game array.

14. An electronic gaming machine as recited in claim 9, wherein the controller actuates a second bonus feature responsive to the detection of a bonus feature trigger in the randomly-selected symbols in the cells of the bonus feature array.

15. An electronic gaming machine as recited in claim 9, wherein the controller analyzes the bonus feature array to detect preset winning combinations, wherein the randomly-selected symbols include poker symbols and the preset winning combinations include poker hands.

16. An electronic gaming machine as recited in claim 9, wherein the display is a touchscreen display.

17. An electronic gaming machine comprising:
a) a display for displaying an underlying game, wherein the underlying game comprises displaying randomly-selected symbols arranged into an underlying game array of cells, wherein preset winning combinations of the randomly selected symbols in the underlying game array actuate the award of prizes; and
b) a controller for controlling the display of randomly-selected symbols in each cell of the underlying game array, analyzing the underlying game array to detect preset winning combination, and detecting the random-selection of a bonus feature trigger symbol in a cell of the underlying game array, the controller configured to actuate a bonus feature responsive the detection of the bonus feature trigger symbol, the bonus feature comprising the display of randomly-selected symbols arranged into a bonus feature array of cells, the bonus feature array of cells being positioned on the display over the cell in the underlying game array having the bonus feature trigger, wherein the controller replaces a portion of the randomly-selected symbols in the underlying game array shown on the display with the randomly-selected symbols in the bonus feature array shown on the display, and is further configured to analyze the underlying game array with replaced symbols to detect preset winning combinations.

18. An electronic gaming machine as recited in claim 17, wherein the controller analyzes the bonus feature array to detect preset winning combinations, wherein the randomly-selected symbols include poker symbols and the preset winning combinations include poker hands.

19. An electronic gaming machine as recited in claim 17, wherein the controller is further configured to receive selections of one or more cells in the underlying game array prior to the play of the underlying game, and actuate the bonus feature responsive to the bonus feature trigger symbol being detected in the one or more selected cells.

20. An electronic gaming machine as recited in claim 1, wherein the underlying game array and bonus feature array are defined by rows and columns, wherein the underlying game array has a greater amount of one of rows or columns than the bonus feature array.
